(19) United States
(12) Patent Application Publication
(10) Pub. No.: US 2022/0351714 A1
(43) Pub. Date: Nov. 3, 2022

(54) TEXT-TO-SPEECH (TTS) METHOD AND DEVICE ENABLING MULTIPLE SPEAKERS TO BE SET

(71) Applicant: LG ELECTRONICS INC., Seoul (KR)

(72) Inventors: Siyoung YANG, Seoul (KR); Minwook KIM, Seoul (KR); Yongchul PARK, Seoul (KR); Juyeong JANG, Seoul (KR); Sungmin HAN, Seoul (KR)

(73) Assignee: LG ELECTRONICS INC., Seoul (KR)

(21) Appl. No.: 16/485,776

(22) PCT Filed: Jun. 7, 2019
(86) PCT No.: PCT/KR2019/006853

§ 371 Date: Aug. 13, 2019

(51) Int. Cl. G10L 13/08; G06F 40/279; G06F 40/143; G10L 13/047

(52) U.S. Cl. CPC G10L 13/08; G06F 40/279; G06F 40/143; G10L 13/047

(57) ABSTRACT

Disclosed is a text-to-speech (TTS) method enabling multiple speakers to be set. The present invention sets speaker information for the multiple characters with respect to a script composed to enable utterance by the multiple characters, and utilizes metadata including the speaker information corresponding to the multiple characters for speech synthesis, thereby realizing an audiobook which allows the multiple speakers to output speech utterance. In addition, the speaker information for the multiple characters may be set through Artificial Intelligence (AI) processing to thereby perform multi-speaker speech synthesis by a TTS device including an AI module.

### CROSS-REFERENCE TO RELATED APPLICATIONS

This application is the National Stage filing under 35 U.S.C. 371 of International Application No. PCT/KR2019/006853, filed on Jun. 7, 2019, the contents of which are all hereby incorporated by reference herein in its entirety.

### TECHNICAL FIELD

The present invention relates to a text-to-speech (TTS) method and device which allows multiple speakers to be set, and more particularly to a TTS method and device which allows multiple speakers to be set so as to perform speech synthesis by customizing an audiobook having multiple characters to a voice desired by a user.

### BACKGROUND ART

A conventional text-to-speech (TTS) processing outputs a text using a pre-stored voice. The primary purpose of the TTS processing is to transmit semantic contents, but recently there is emerging need that the TTS processing transmits not just semantic contents of a text but also interactive contents of the text to a counterpart, so that intent or emotion of a user actually transmitting the text is reflected in a voice output, thereby allowing interactive conversation with the actual text transmitter.

### DISCLOSURE

### Technical Problem

The present invention aims to address the above-described need and/or problem.

In addition, the present invention aims to perform speech synthesis with respect to a script, subject to speech synthesis, with a voice desired by a user.

In addition, the present invention aims to realize multi-speaker speech utterance by matching a user's desired speaker for each of multiple characters in a process of outputting audio of an audiobook having a story which includes the multiple characters.

In addition, the present invention aims to realize a TTS method and device which allows a speaker to be set easily using speech synthesis markup language (SSML).

In addition, the present invention aims to realize a TTS method and apparatus which allows a user to set multiple speakers more easily, and a TTS device implementing the same.

### Technical Solution

A text-to-speech (TTS) method enabling multiple speakers to be set according to one aspect of the present invention includes: setting speaker information for the multiple characters with respect to a script configured such that utterance can be spoken by the multiple character; transmitting metadata, comprising the speaker information corresponding to the multiple characters, together with the script to a speech synthesis unit; performing, by the speech synthesis unit, speech synthesis based on the metadata; and outputting a result of the speech synthesis to an acoustic output unit.

The metadata may be described in markup language, and the markup language comprises speech synthesis markup language (SSML).

The SSML may include an element for expressing the speaker information, and the element may include at least one of speaker_id, speaker_profile, story_id, or story profile.

The speaker_id may be used to identify a speaker and described together with at least a part of the script that is subject to the speech synthesis.

The speaker_profile may include at least one of the following: the speaker id, name of the speaker, a character to be synthesized with a voice of the speaker, age of the speaker, language used by the speaker, a country of the speaker, a continent to which the country of the speaker belongs to, and a city to which the speaker belongs.

When voices of different characters are synthesized by a same speaker, different speaker IDs may be respectively set for the different characters.

The speaker_profile may be described using an independent speaker ID set for the speaker_id.

The story_id may be an identifier for identifying a content on which speech synthesis is to be performed based on the script.

The story_profile may include at least one of the story_id, a story title, a character included in the story, or the speaker_id, and the character may be described as being matched with the speaker_id.

The method may further include storing the speaker information in a storage, and the setting the speaker information for the multiple characters may further include: searching for the stored speaker information based on an input received through a user input unit; and matching the speaker information for each of the multiple characters based on the input received through the user input unit.

The setting of the speaker information for the multiple characters may further include: extracting keywords of the multiple characters by analyzing characteristics of the multiple characters included in the script; based on the keywords, searching for speaker information stored in a memory; and matching speaker information, determined suitable for the keywords, with the multiple characters.

The setting of the speaker information for the multiple characters may be performed by receiving speaker information matched with each of the multiple characters from an external server.

A text-to-speech (TTS) device enabling multiple speakers to be set according to another aspect of the present invention includes: a speech synthesis unit; a memory configured to store information on the multiple speakers and a script; and a processor configured to control the speech synthesis unit to synthesize a speech corresponding to the script by reflecting speaker information set in the script, and the processor may be configured to: set the information on the speakers for the multiple characters with respect to the script that is composed to enable utterance by the multiple characters; transmit metadata, including the information on the speakers corresponding to the multiple characters, together with the script to the speech synthesis unit; based on the metadata, perform speech synthesis by the speech synthesis unit; and output a result of the speech synthesis through an acoustic output unit.

The TTS device may be an audio book.

The TTS device may be an Artificial Intelligence (AI) speaker including an AI module capable of performing AI processing.

A system according to yet another aspect of the present invention includes: a means configured to set speaker information for multiple characters with respect to a script that is composed to enable utterance by the multiple characters; a means configured to transmit metadata, comprising the speaker information corresponding to the multiple characters, together with the script to a speech synthesis unit; and a means configured to perform speech synthesis by the speech synthesis unit based on the metadata; and a means configured to output a result of the speech synthesis through an acoustic output unit.

An electronic device according to yet another aspect of the present invention includes: one or more processors; a memory; and one or more programs, wherein the one or more programs are stored in the memory and configured to be executed by the one or more processors and comprises an instruction for implementing the above-described method enabling multiple speakers to be set.

A recording medium according to yet another aspect of the present invention is a non-transitory computer-executable component in which a computer-executable component configured to be executed by one or more processors of a computing device is stored, wherein the computer-executable component is configured to: set speaker information for multiple characters with respect to a script that is composed to enable utterance by the multiple characters; transmit metadata, comprising the speaker information corresponding to the multiple characters, together with the script to a speech synthesis unit; and, based on the metadata, perform speech synthesis by the speech synthesis unit.

### Advantageous Effects

A text-to-speech (TTS) method and device which allows multiple speakers to be set according to the present invention has effects as below.

The present invention may perform speech synthesis with respect to a script, subject to speech synthesis, with a voice desired by a user.

In addition, the present invention may realize multi-speaker speech utterance by matching a user's desired speaker for each of multiple characters in a process of outputting audio of an audiobook having a story which includes the multiple characters.

In addition, the present invention may realize a TTS method and device which allows a speaker to be set easily using speech synthesis markup language (SSML).

In addition, the present invention may realize a TTS method and apparatus which allows a user to set multiple speakers more easily.

The effects of the present invention are not limited to the effects described above, and other effects not mentioned herein may be understood to those skilled in the art from the description below.

### DESCRIPTION OF DRAWINGS

The accompany drawings, which are included to provide a further understanding of the present invention and are incorporated on and constitute a part of this specification illustrate embodiments of the present invention and together with the description serve to explain the principles of the present invention.

FIG. 1 shows an example of a block diagram of a wireless communication system to which methods proposed in the present specification is applicable.

FIG. 2 is a diagram showing an example of a signal transmitting/receiving method in a wireless communication system.

FIG. 3 shows an example of a user terminal and a 5G network in a 5G communication system.

FIG. 4 shows an example of a schematic block diagram in which a text-to-speech (TTS) method according to an embodiment of the present invention is implemented.

FIG. 5 is a diagram for explaining a TTS method according to an embodiment of the present invention.

FIG. 6 is a block diagram of an Artificial Intelligence (AI) device which is applicable to an embodiment of the present invention.

FIG. 7 is an exemplary block diagram of a TTS device according to an embodiment of the present invention.

FIG. 8 is another exemplary block diagram of a TTS device according to an embodiment of the present invention.

FIG. 9 is a flowchart of a TTS method which allows multiple speakers to be set according to an embodiment of the present invention.

FIG. 10 is an exemplary flowchart of a method for setting multiple speakers according to an embodiment of the present invention.

FIG. 11 is an exemplary flowchart of a method for setting a speaker according to an embodiment of the present invention.

FIG. 12 is an example of representing a speaker ID in speech synthesis markup language (SSML) and applying the speaker ID to utterance.

FIGS. 13 and 14 are examples of representing a speaker profile using SSML.

FIG. 15 is an example of setting the same speaker for multiple characters using SSML, whilst setting different speaker IDs and applying the different speaker IDs to utterance.

FIG. 16 is an example of representing a story ID and a story profile using SSML.

FIG. 17 is an example of matching a character included in a script of an audio book and a speaker according to an embodiment of the present invention.

FIG. 18 is an example of outputting an audiobook after setting a speaker using SSML according to an embodiment of the present invention.

The accompanying drawings, which are included to provide a further understanding of the invention and are incorporated in and constitute a part of this application, illustrate embodiments of the invention and together with the description serve to explain the principle of the invention.

### MODE FOR INVENTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

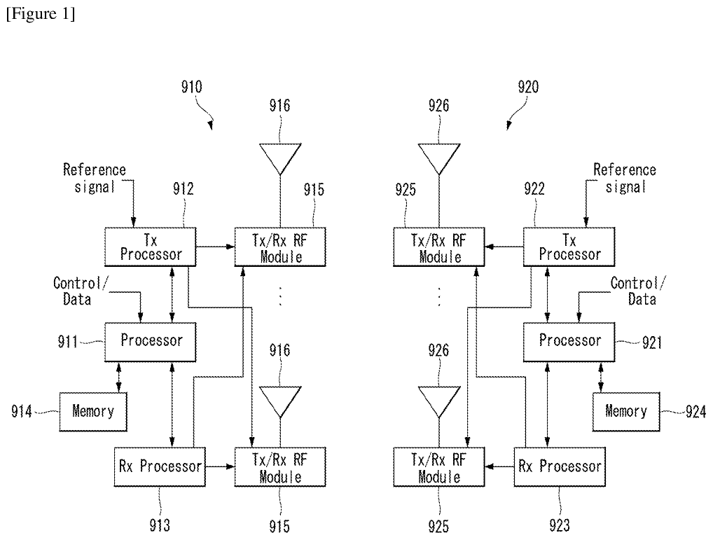

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

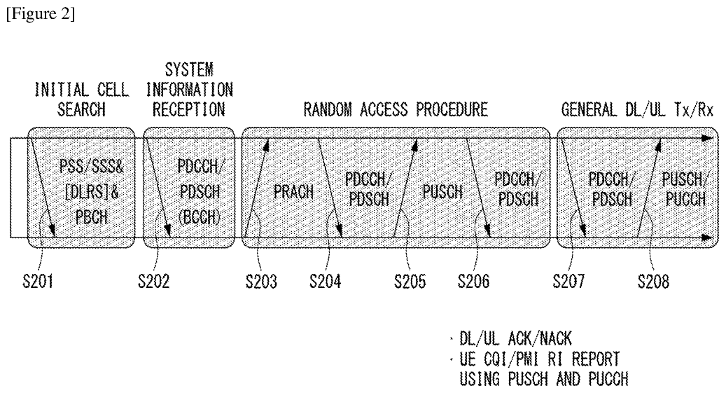

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

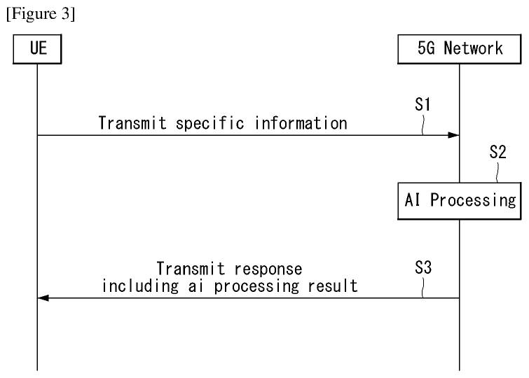

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

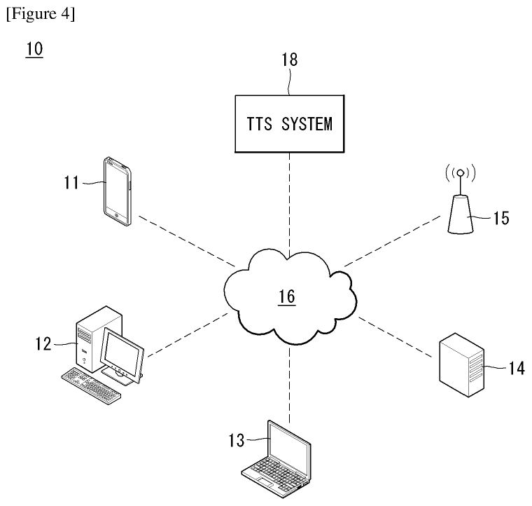

FIG. 4 illustrates a block diagram of a schematic system in which a speech synthesis method is implemented according to an embodiment of the present invention.

Referring to FIG. 4, a system for implementing a speech synthesis method according to an embodiment of the present invention may include a text-to-to-speech device as a speech synthesis apparatus 10, a network system 16, and a speech synthesis engine. Speech system 18 may be included.

The at least one speech synthesizing apparatus 10 may include a mobile phone 11, a PC 12, a notebook computer 13, and other server devices 14. The PC 12 and notebook computer 13 may be connected to at least one network system 16 via a wireless access point 15. According to an embodiment of the present invention, the speech synthesis apparatus 10 may include an audio book and a smart speaker.

Meanwhile, the TTS system 18 may be implemented in a server included in a network, or may be implemented by on-device processing and embedded in the speech synthesis apparatus 10. In the exemplary embodiment of the present invention, the TTS system 18 will be described on the premise that the TTS system 18 is implemented in the speech synthesis apparatus 10.

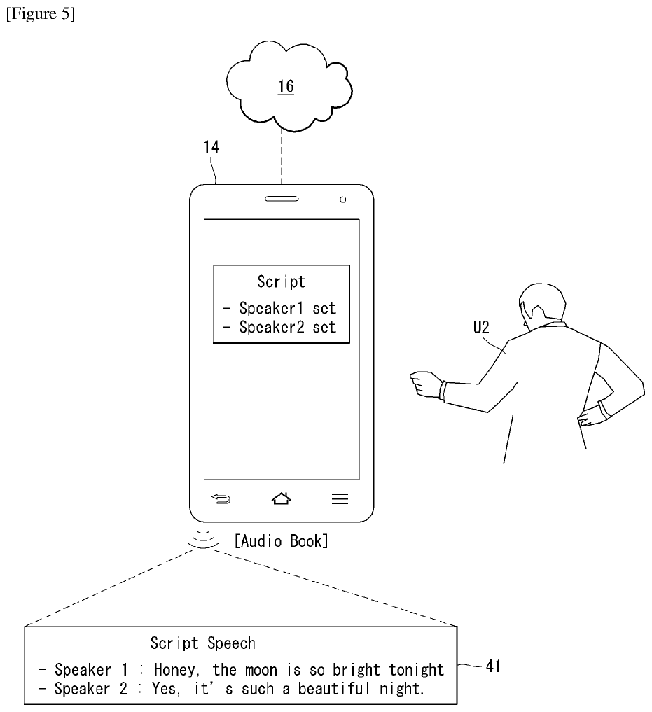

FIG. 5 is a diagram illustrating a concept of implementing a speech synthesis method according to an embodiment of the present invention.

Referring to FIG. 5, a speech synthesis apparatus according to an embodiment of the present invention may be an audio book, and the audio book may store text, which is a speech synthesis target, in a memory. This text is referred to as a script in this document. The user U2 may set a plurality of speakers 1 and speaker 2 for the script output from the audio book 11 as voice. The audio book 11 may provide a user interface capable of setting a plurality of speakers. When a plurality of speakers are set through the user interface, a script may be synthesized and output into voices corresponding to the plurality of speakers, respectively (41). In addition, the audio book 11 may receive a result of setting a plurality of speakers from the network system 16 through the wireless communication unit. The audio book 11 may synthesize and output a voice corresponding to a script based on a speaker setting result received from the network system 16.

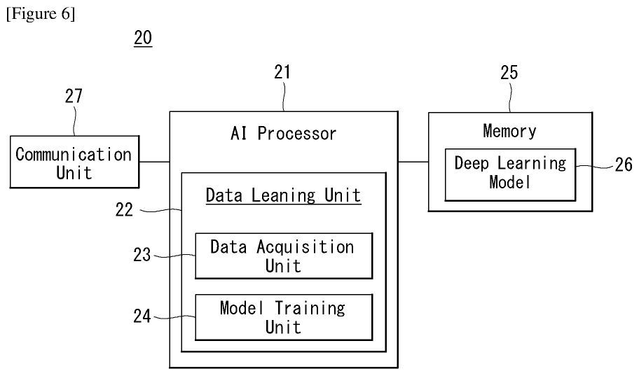

FIG. 6 is a block diagram of an Artificial Intelligence (AI) device implementable that can apply to an embodiment of the present invention.

The AI device 20 may include an electronic device including an AI module capable of performing AI processing or a server including the AI module. In addition, the AI device 20 may be provided as an element of at least a part of the TTS device 10 shown in FIG. 4 and configured to perform at least a part of the AI processing.

The AI processing may include all operations related to speech synthesis performed by the TTS device 10 shown in FIG. 4. For example, the AI processing may be a process of analyzing a script of the TTS device 10 to set the most suitable speakers respectively corresponding to multiple characters present in the script. The AI processing may analyze the multiple characters present in the script and provide character characteristics to a user. The user may select the most suitable speaker for each character included in consideration of character characteristics according to a result of the AI processing.

The AI device 20 may include an AI processor 21, a memory 25 and/or a communication unit 27.

The AI device 20 is a computing device capable of training a neural network and may be implemented as any of various electronic devices such as a server, a desktop PC, a laptop PC, a tablet PC, etc.

The AI processor 21 may train a neural network using a program stored in the memory 25.

In particular, the AI processor 21 may analyze a script and train a neural network for recognizing the best suitable speakers for characters present in the script. Here, the neural network for recognizing the best suitable speaker may be designed to simulate a human brain structure in a computer and may include a plurality of weighted network nodes that simulate neurons of a human neural network.

The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks(CNN), recurrent neural networks (RNN), a restricted boltzmann machine (RBM), deep belief networks (DBN), and a deep Q-network, and can be applied to fields such as computer vision, voice recognition, natural language processing, and voice/signal processing.

Meanwhile, a processor that performs the functions described above may be a general purpose processor (e.g., a CPU), but may be an AI-only processor (e.g., a GPU) for artificial intelligence learning.

The memory 25 can store various programs and data for the operation of the AI device 20. The memory 25 may be a nonvolatile memory, a volatile memory, a flash-memory, a hard disk drive (HDD), a solid state drive (SDD), or the like. The memory 25 is accessed by the AI processor 21 and reading-out/recording/correcting/deleting/updating, etc. of data by the AI processor 21 can be performed. Further, the memory 25 can store a neural network model (e.g., a deep learning model 26) generated through a learning algorithm for data classification/recognition according to an embodiment of the present invention.

Meanwhile, the AI processor 21 may include a data learning unit 22 that learns a neural network for data classification/recognition. The data learning unit 22 can learn references about what learning data are used and how to classify and recognize data using the learning data in order to determine data classification/recognition. The data learning unit 22 can learn a deep learning model by acquiring learning data to be used for learning and by applying the acquired learning data to the deep learning model.

The data learning unit 22 may be manufactured in the type of at least one hardware chip and mounted on the AI device 20. For example, the data learning unit 22 may be manufactured in a hardware chip type only for artificial intelligence, and may be manufactured as a part of a general purpose processor (CPU) or a graphics processing unit (GPU) and mounted on the AI device 20. Further, the data learning unit 22 may be implemented as a software module. When the data leaning unit 22 is implemented as a software module (or a program module including instructions), the software module may be stored in non-transitory computer readable media that can be read through a computer. In this case, at least one software module may be provided by an OS (operating system) or may be provided by an application.

The data learning unit 22 may include a learning data acquiring unit 23 and a model learning unit 24.

The learning data acquiring unit 23 can acquire learning data required for a neural network model for classifying and recognizing data. For example, the learning data acquiring unit 23 can acquire, as learning data, vehicle data and/or sample data to be input to a neural network model.

The model learning unit 24 can perform learning such that a neural network model has a determination reference about how to classify predetermined data, using the acquired learning data. In this case, the model learning unit 24 can train a neural network model through supervised learning that uses at least some of learning data as a determination reference. Alternatively, the model learning data 24 can train a neural network model through unsupervised learning that finds out a determination reference by performing learning by itself using learning data without supervision. Further, the model learning unit 24 can train a neural network model through reinforcement learning using feedback about whether the result of situation determination according to learning is correct. Further, the model learning unit 24 can train a neural network model using a learning algorithm including error back-propagation or gradient decent.

When a neural network model is learned, the model learning unit 24 can store the learned neural network model in the memory. The model learning unit 24 may store the learned neural network model in the memory of a server connected with the AI device 20 through a wire or wireless network.

The data learning unit 22 may further include a learning data preprocessor (not shown) and a learning data selector (not shown) to improve the analysis result of a recognition model or reduce resources or time for generating a recognition model.

The learning data preprocessor can preprocess acquired data such that the acquired data can be used in learning for situation determination. For example, the learning data preprocessor can process acquired data in a predetermined format such that the model learning unit 24 can use learning data acquired for learning for image recognition.

Further, the learning data selector can select data for learning from the learning data acquired by the learning data acquiring unit 23 or the learning data preprocessed by the preprocessor. The selected learning data can be provided to the model learning unit 24. For example, the learning data selector can select only data for objects included in a specific area as learning data by detecting the specific area in an image acquired through a camera of a vehicle.

Further, the data learning unit 22 may further include a model estimator (not shown) to improve the analysis result of a neural network model.

The model estimator inputs estimation data to a neural network model, and when an analysis result output from the estimation data does not satisfy a predetermined reference, it can make the model learning unit 22 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 27 can transmit the AI processing result by the AI processor 21 to an external electronic device.

Here, the external electronic device may be defined as an autonomous vehicle. Further, the AI device 20 may be defined as another vehicle or a 5G network that communicates with the autonomous vehicle. Meanwhile, the AI device 20 may be implemented by being functionally embedded in an autonomous module included in a vehicle. Further, the 5G network may include a server or a module that performs control related to autonomous driving.

Meanwhile, the AI device 20 shown in FIG. 5 was functionally separately described into the AI processor 21, the memory 25, the communication unit 27, etc., but it should be noted that the aforementioned components may be integrated in one module and referred to as an AI module.

Here, in a case where the AI processor 21 is included in a network system, the external electronic device may be a text-to-speech (TTS) device according to an embodiment of the present invention.

Meanwhile, the AI device 20 shown in FIG. 5 is described by functionally classifying into the AI processor 21, the memory 25, the communication unit 27, etc., yet these constituent components can be integrated as one module and referred to as an AI module.

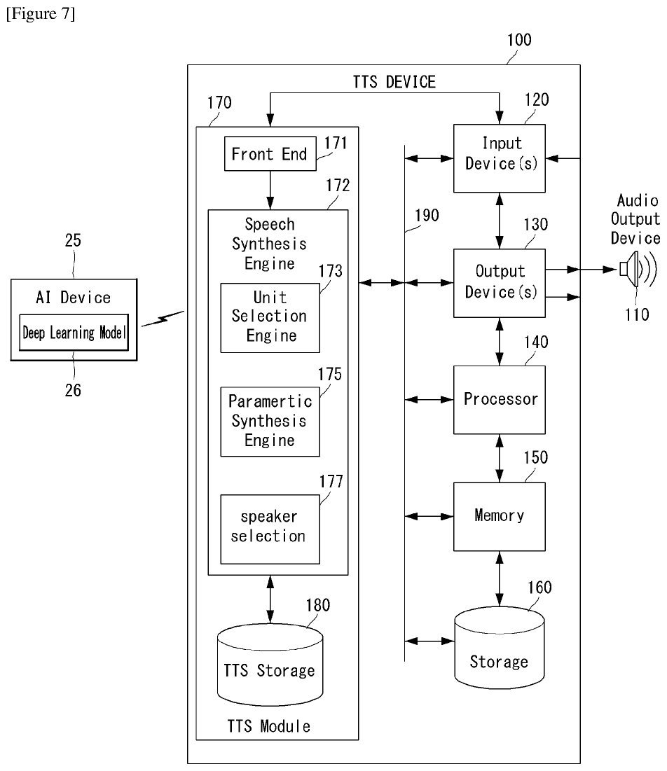

FIG. 7 is an exemplary block diagram of a text-to-speech (TTS) device according to an embodiment of the present invention.

A TTS device 100 shown in FIG. 7 may include an audio output device 110 for outputting a voice processed by the TTS device 100 or by a different device.

FIG. 7 discloses the TTS device 100 for performing speech synthesis. An embodiment of the present invention may include computer-readable and computer-executable instructions that can be included in the TTS device 100. Although FIG. 7 discloses a plurality of elements included in the TTS device 100, configurations not disclosed herein may be included in the TTS device 100.

Meanwhile, some configurations disclosed in the TTS device 100 may be single configurations and each of them may be used multiple times in one device. For example, the TTS device 100 may include a plurality of input devices 120, an output device 130 or a plurality of controllers/processors 140.

A plurality of TTS devices may be applied to one TTS device. In such a multiple device system, the TTS device may include different configurations to perform various aspects of speech synthesis. The TTS device shown in FIG. 7 is merely an exemplary, may be an independent device, and may be implemented as one configuration of a large-sized device or system.

According to an embodiment of the present invention, a plurality of difference devices and a computer system may be, for example, applied to a universal computing system, a server-client computing system, a telephone computing system, a laptop computer, a mobile terminal, a PDA, and a tablet computer, etc. The TTS device 100 may be applied as a different device providing a speech recognition function, such as ATMs, kiosks, a Global Positioning System (GPS), a home appliance (e.g., a refrigerator, an oven, a washing machine, etc.), vehicles, ebook readers, etc. or may be applied as a configuration of the system.

Referring to FIG. 7, the TTS device 100 may include a speech output device 110 for outputting a speech processed by the TTS device 100 or by a different device. The speech output device 110 may include a speaker, a headphone, or a different appropriate configuration for transmitting a speech. The speech output device 110 may be integrated into the TTS device 100 or may be separated from the TTS device 100.

The TTS device 100 may include an address/data bus 224 for transmitting data to configurations of the TTS device 100. The respective configurations in the TTS device 100 may be directly connected to different configurations through the bus 224. Meanwhile, the respective configurations in the TTS device 100 may be directly connected to a TTS module 170.

The TTS device 100 may include a controller (processor) 140. A processor 208 may correspond to a CPU for processing data and a memory for storing computer-readable instructions to process data and storing the data and the instructions. The memory 150 may include a volatile RAM, a non-volatile ROM, or a different-type memory.

The TTS device 100 may include a storage 160 for storing data and instructions. The storage 160 may include a magnetic storage, an optical storage, a solid-state storage, etc.

The TTS device 100 may access a detachable or external memory (e.g., a separate memory card, a memory key drive, a network storage, etc.) through an input device 120 or an output device 130.

Computer instructions to be processed by the processor 140 to operate the TTS device 100 and various configurations may be executed by the processor 140 and may be stored in the memory 150, the storage 160, an external device, or a memory or storage included in the TTS module 170 described in the following. Alternatively, all or some of executable instructions may be added to software and thus embedded in hardware or firmware. An embodiment of the present invention may be, for example, implemented as any of various combinations of software, firmware and/or hardware.

The TTs device 100 includes the input device 120 and the output device 130. For example, the input device a microphone, a touch input device, a keyboard, a mouse, a stylus, or the audio output device 100 such as a different input device. The output device 130 may include a visual display or tactile display, an audio speaker, a headphone, a printer, or any other output device. The input device 120 and/or the output device 130 may include an interface for connection with an external peripheral device, such as a Universal Serial Bus (USB), FireWire, Thunderbolt, or a different access protocol. The input device 120 and/or the output device 130 may include a network access such as an Ethernet port, a modem, etc. The input device 120 and/or the output device may include a wireless communication device such as radio frequency (RF), infrared rays, Bluetooth, wireless local area network (WLAN) (e.g., WiFi and the like) or may include a wireless network device such as a 5G network, a long term evolution (LTE) network, a WiMAN network, and a 3G network. The TTS device 100 may include the Internet or a distributed computing environment through the input device 120 and/or the output device 130.

The TTS device 100 may include the TTS module 170 for processing textual data into audio waveforms including speeches.

The TTS module 170 may access to the bus 224, the input device 120, the output device 130, the audio output device 110, the processor 140, and/or a different configuration of the TTS device 100.

The textual data may be generated by an internal configuration of the TTS device 100. In addition, the textual data may be received from an input device such as a keyboard or may be transmitted to the TTS device 100 through a network access. A text may be a type of a sentence including a text, a number and/or a punctuation to convert into a speech by the TTS module 170. An input text may include a special annotation for processing by the TTS module 170 and may use the special annotation to indicate how a specific text is to be pronounced. The textual data may be processed in real time or may be stored or processed later on.

The TTS module 170 may include a front end 171, a speech synthesis engine 172, and a TTS storage 180. The front end 171 may convert input textual data into symbolic linguistic representation for processing by the speech synthesis engine 172. The speech synthesis engine 172 may convert input text into a speech by comparing annotated phonetic unit models and information stored in the TTS storage 180. The front end 171 and the speech synthesis engine 172 may include an embedded internal processor or memory, or may use a processor 140 included in the TTS device 100 or a memory. Instructions for operating the front end 171 and the speech synthesis engine 172 may be included in the TTS module 170, the memory 150 of the TTS device 100, the storage 160, or an external device.

Input of a text into the TTS module 170 may be transmitted to the front end 171 for a processing. The front end 171 may include a module for performing text normalization, linguistic analysis, and linguistic prosody generation.

While performing the text normalization, the front end 171 may process a text input and generate a standard text to thereby convert numbers, abbreviations, and symbols identically.

While performing the linguistic analysis, the front end 171 may generate language of a normalized text to generate a series of phonetic units corresponding to an input text. This process may be referred to as phonetic transcription. The phonetic units include symbol representation of sound units that are lastly coupled and output by the TTS device 100 as a speech. Various sound units may be used to divide a text for speech synthesis. The TTS module 170 may process a speech based on phonemes (individual acoustics), half-phonemes, di-phones (the last half of a phoneme coupled to a half of a neighboring phoneme), bi-phones (two continuous phones), syllables, words, phrases, sentences, or other units. Each word may be mapped to one or more phonetic units. Such mapping may be performed using a language dictionary stored in the TTS device 100.

Linguistic analysis performed by the front end 171 may include a process of identifying different syntactic elements, such as prefixes, suffixes, phrases, punctuations, and syntactic boundaries. Such syntactic elements may be used to output a natural audio waveform by the TTS module 170. The language dictionary may include letter-to-sound rules and other tools for pronouncing a previously unidentified word or letter combination that can be made by the TTS module 170. In general, the more the information is included in the language dictionary, the higher the quality of speech output can be ensured.

Based on the linguistic analysis, the front end 171 may generate linguistic prosody of which annotation is processed to prosodic characteristics so that phonetic units represent how final acoustic units has to be pronounced in a final output speech.

The prosodic characteristics may be referred to as acoustic features. While an operation of this step is performed, the front end 171 may integrate the acoustic features into the TTS module 170 in consideration of random prosodic annotations that accompanies a text input. Such acoustic features may include pitch, energy, duration, etc. Application of the acoustic features may be based on prosodic models that can be used by the TTS module 170. Such prosodic models represent how phonetic units are to be pronounced in a specific situation. For example, the prosodic models may take into consideration of a phoneme's position in a syllable, a syllable's position in a word, a word's position in a sentence or phrase, neighboring phonetic units, etc. Likewise to the language dictionary, the more information on prosodic models exists, the higher the quality of speech output is ensured.

An output from the front end 171 may include a series of phonetic units which are annotation-processed into prosodic characteristics. The output from the front end 171 may be referred to as symbolic linguistic representation. The symbolic linguistic representation may be transmitted to the speech synthesis engine 172. The speech synthetic engine 172 may convert the speech into an audio wave so as to output the speech to a user through the audio output device 110. The speech synthesis engine 172 is configured to convert an input test into a high-quality natural speech in an efficient way. Such a high-quality speech may be configured to be pronounced in a similar way of a human speaker as much as possible.

The speech synthesis engine 172 may perform synthesis using at least one or more other methods.

The unit selection engine 173 compares a recorded speech database with a symbolic linguistic representation generated by the front end 171. The unit selection engine 173 matches the symbol linguistic representation and a speech audio unit in the recorded speech database. In order to form a speech output, matching units may be selected and the selected matching units may be connected to each other. Each unit includes audio waveforms, which correspond to a phonetic unit such as a short WAV file of specific sound along with description of various acoustic features associated with the WAV file (pitch, energy, etc.), and also includes other information such as a position at which the phonetic unit is represented in a word, a sentence, a phrase, or a neighboring phonetic unit.

The unit selection engine 173 may match an input text using all information in a unit database in order to generate a natural waveform. The unit database may include examples of multiple speech units that provide different options to the TTS device 100 to connect the units to a speech. One of advantages of unit selection is that a natural speech output can be generated depending on a size of the database. In addition, the greater the unit database, the more natural the speech can be constructed by the TTS device 100.

Meanwhile, speech synthesis can be performed not just by the above-described unit selection synthesis, but also by parameter synthesis. In the parameter synthesis, synthesis parameters such as frequency, volume, and noise can be varied by a parameter synthesis engine 175, a digital signal processor, or a different audio generating device in order to generate artificial speech waveforms.

The parameter synthesis may match symbolic linguistic representation with a desired output speech parameter by using an acoustic model and various statistical techniques. In the parameter synthesis, a speech can be processed even without a large-capacity database related to unit selection and a processing can be performed at a high speed. The unit selection synthesis technique and the parameter synthesis technique may be performed individually or in combination to thereby generate a speech audio output.

The parameter speech synthesis may be performed as follows. The TTS module 170 may include an acoustic model that can transform symbolic linguistic representation into a synthetic acoustic waveform of a test input based on audio signal manipulation. The acoustic model may include rules that can be used by the parameter synthesis engine 175 to allocate specific audio waveform parameters to input phonetic units and/or prosodic annotations. The rules may be used to calculate a score indicating a probability that a specific audio output parameter (frequency, volume, etc.) may correspond to input symbolic linguistic representation from the pre-processor 171.

The parameter synthesis engine 175 may apply multiple techniques to match a speech to be synthesized with an input speech unit and/or a prosodic annotation. One of general techniques employs Hidden Markov Model (HMM). The HMM may be used to determine a probability for an audio output to match a text input. In order to artificially synthesize a desired speech, the HMM may be used to convert linguistic and acoustic space parameters into parameters to be used by a vocoder (digital voice encoder).

The TTS device 100 may include a speech unit database to be used for unit selection.

The speech unit database may be stored in the TTS storage 180, the storage 160, or another storage configuration. The speech unit database may include a recorded speech voice. The speech voice may be a text corresponding to utterance contents. In addition, the speech unit database may include a recorded speech (in the form of an audio waveform, a feature factor, or another format) occupying a considerable storage space in the TTS device 100. Unit samples in the speech unit database may be classified in various ways including a phonetic unit (a phoneme, a diphone, a word, and the like), a linguistic prosody label, an acoustic feature sequence, a speaker identity, and the like.

When matching symbolic linguistic representation, the speech synthesis engine 172 may select a unit in the speech unit database that most closely matches an input text (including both a phonetic unit and a prosodic symbol annotation). In general, the large the capacity of the speech unit database, the more the selectable unit samples and thus the more accurate the speech output.

Audio waveforms including a speech output to a user may be transmitted to the audio output device 110 from the TTS module 213 so that the audio waveforms are output to a user. Audio waveforms including a speech may be stored in multiple different formats such as feature vectors, non-compressed audio data, or compressed audio data. For example, an audio output may be encoded and/or compressed by an encoder/decoder before the transmission. The encoder/decoder may encode or decode audio data such as digitalized audio data, feature vectors, etc. In addition, the function of the encoder/decoder may be included in an additional component or may be performed by the processor 140 and the TTS module 170.

Meanwhile, the TTS storage 180 may store different types of information for speech recognition.

Contents in the TTS storage 180 may be prepared for general TTS usage and may be customized to include sound and words that can be used in a specific application. For example, for TTS processing by a GPS device, the TTS storage 180 may include a customized speech specialized in position and navigation.

In addition, the TTS storage 180 may be customized to a user based on a personalized desired speech output. For example, the user may prefer an output voice of a specific gender, a specific accent, a specific speed, a specific emotion (e.g., a happy voice). The speech synthesis engine 172 may include a specialized database or model to explain such user preference.

The TTs device 100 may perform TTS processing in multiple languages. For each language, the TTS module 170 may include data, instructions, and/or components specially configured to synthesize a speech in a desired language.

For performance improvement, the TTS module 213 may modify or update contents of the TTS storage 180 based on a feedback on a TTS processing result, and thus, the TTS module 170 may improve speech recognition beyond a capability provided by a training corpus.

As the processing capability of the TTS device 100 improves, a speech output is possible by reflecting an attribute of an input text. Alternatively, although an emotion attribute is not included in the input text, the TTS device 100 may output a speech by reflecting intent (emotion classification information) of a user who has written the input text.

Indeed, when a model to be integrated into a TTS module for performing TTS processing is established, the TTS system may integrate the above-described various configurations and other configurations. For example, the TTS device 100 may insert an emotion element into a speech.

In order to output the speech added with the emotion classification information, the TTS device 100 may include an emotion insertion module 177. The emotion insertion module 177 may be integrated into the TTS module 170 or integrated as a part of the pre-processor 171 or the speech synthesis engine 172. The emotion insertion module 177 may realize emotion classification information-based TTS using metadata that corresponds to an emotion attribute. According to an embodiment of the present invention, the metadata may be in markup language and preferably in speech synthesis markup language (SSML). A method of performing emotion classification information-based TTS using SSML will be hereinafter described in detail.

In fact, when a model to be integrated into a TTS module for performing a TTS processing is established, the TTS system may integrate another constituent component with the aforementioned various constituent components. For example, the TTS device 100 may include a block for setting a speaker.

A speaker setting unit 177 may set an individual speaker for each character included in a script. The speaker setting unit 177 may be integrated into a TTS module 170 or may be integrated as a part of a pre-processor 171 or a speech synthesis engine 172. The speaker setting unit 177 synthesizes texts corresponding to multiple characters with a voice of a set speaker using metadata corresponding to a speaker profile.

According to an embodiment of the present invention, the metadata may use markup language and may preferably use speech synthesis markup language (SSML).

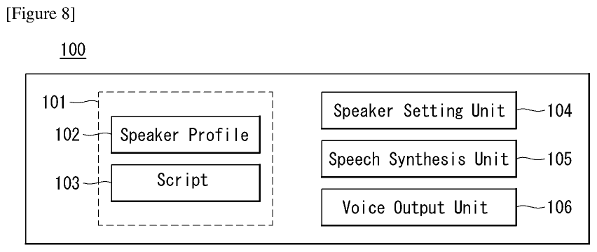

FIG. 8 is an exemplary block diagram of a TTS device according to an embodiment of the present invention.

Referring to FIG. 8, the TTS device 100 may include a memory 101 for storing speaker information, a speaker setting unit 104, a speech synthesis unit 105, and a voice output unit 106.

The memory 101 may store a speaker profile 102 and a script 103.

The speaker profile 102 may include at least one of the following: a name of the speaker, a character synthesized in the speaker's voice; age of the speaker, language used by the speaker; country of the speaker; continent to which the country of the speaker belongs; and city to which the speaker belongs. The name of the speaker may be a name of a voice actor of an audio book. The character may include names of multiple characters in the audiobook, descriptions about the characters, etc. Age information of the speaker may be reference information to be referred to when a user selects a speaker suitable for characteristics of the character. In addition, the reference information may further include the language used by the speaker, the country of the speaker, the continent to which the country of the speaker belongs to, the city where the speaker lives, etc.

As a result, there is an advantageous effect that a speaker can be selected from a wide range according to a speech content to be output from the audio book.

The script may include a text which is a target of speech synthesis of the audio book. The script may be stored in a manner of being divided into multiple characters in the audiobook.

The speaker setting unit 104 may be set by matching the script 103 with the speaker profile 102 stored in the memory. Speaker setting may be performed by setting a character and a speaker in accordance with an input applied through a user input unit of the audio book. Further, speaker setting may be performed by analyzing the script through an AI processing and selecting a speaker suitable for a character by an AI module.

The speech synthesis unit 105 may perform speech synthesis based on a speaker for each character set by the speaker setting unit 104. The speech synthesis may be performed through a function described with reference to the speech synthesis engine 172 shown in FIG. 7.

Hereinafter, a method for displaying markup language in a TTS device capable of outputting multi-speakers' utterance in SSML, a method for selecting multiple speakers, and a method for transmitting information on a selected speaker to the speech synthesis engine will be described in detail with reference to the drawings.

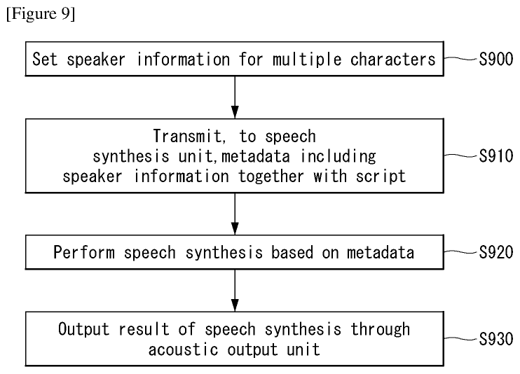

FIG. 9 is a flowchart of a TTS method enabling multiple speakers to be set according to an embodiment of the present invention.

The TTS method enabling multiple speakers to be set according to an embodiment of the present invention may be implemented by the TTS device described above with reference to FIGS. 1 to 8. Meanwhile, the TTS method according to an embodiment of the present invention may be implemented by the processor 140 (see FIG. 7) of the TTS device according to an embodiment of the present invention.

Referring to FIG. 9, the processor 140 may set speaker information for multiple characters with respect to a script composed to enable utterance by the multiple characters (S900).

In a case where there are three characters in the script, the processor 140 may set a first speaker, a second speaker, and a third speaker to be synthesized with utterance of the respective characters, with reference to speaker profile.

The processor 140 may transmit metadata, including speaker information corresponding to the multiple speakers, together with the script to the speech synthesis unit (S910).

The metadata may be transmitted in various ways.

The metadata is described in markup language, and the markup language may include speech synthesis markup language (SSML).

For example, the metadata may be described in markup language such as extensible markup language (XML) and speech synthesis markup language (SSML). The SSML is the standard of markup language for synthesizing a speech and disclosed in https://www.w3.org/TR/2010/REC-speech-synthesis11-20100907/. The markup language may consist of elements, and each of the elements has an attribute.

The TTS device enabling multiple speakers to be set according to an embodiment of the present invention may include an element for expressing speaker information in the SSML standard so as to set a speaker. An element for expressing the speaker information may include speaker_id and speaker_profile and may further include information on a story for matching a speaker and a character. The information on the story may include the story_id and the story_profile.

The processor 140 may perform speech synthesis in the speech synthesis unit based on the metadata (S920).

The speech synthesis unit synthesizes a speech of a specific character with a voice of a specific speaker by reflecting speaker information set in the script.

The processor 140 may output the speech synthetic result to the acoustic output unit (S930).

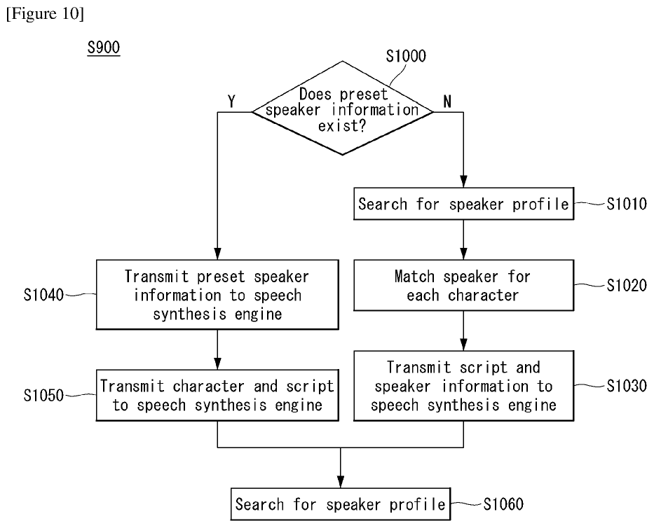

Hereinafter, a more specific method by which the processor 140 sets speaker information for multiple characters in a script composed to enable utterance by the multiple characters will be described with reference to FIG. 10.

FIG. 10 is an exemplary flowchart of a method for setting a speaker according to an embodiment of the present invention.

Referring to FIG. 10, the processor 170 may determine as to whether preset speaker information exists in the TTS device (S1000).

For example, information on different speakers for all characters in a story of an audio book may be set as a default setting. In this case, according to an embodiment, speech synthesis operation may be performed on the script based on preset speaker information.

To this end, the processor 170 may transmit the present speaker information to the speech synthesis engine (S1040). Thereafter, the processor 170 may transmit data, in which the characters and the script are matched, to the speech synthesis engine (S1050). The speech synthesis engine may perform speech synthesis on a script, matched with the character, with a voice of a preset speaker and output a result of the speech synthesis (S1060).

Meanwhile, the TTS device enabling multiple speakers to be set according to an embodiment of the present invention may acquire a speaker setting result as an AI processing result.

Meanwhile, in a case where preset speaker information does not exist in the TTS device (S1000:N), the processor 170 may search for a speaker profile (S1010).

The processor 170 may perform a speaker matching process for matching a speaker for an individual character from a found speaker profile. The speaker matching process may be performed in response to a user input or may be performed automatically.

The processor 170 may transmit the script and speaker information matched with the script to the speech synthesis engine (S1030). The speech synthesis engine may perform speech synthesis by using the speaker information as metadata and output a result of the speech synthesis (S1060).

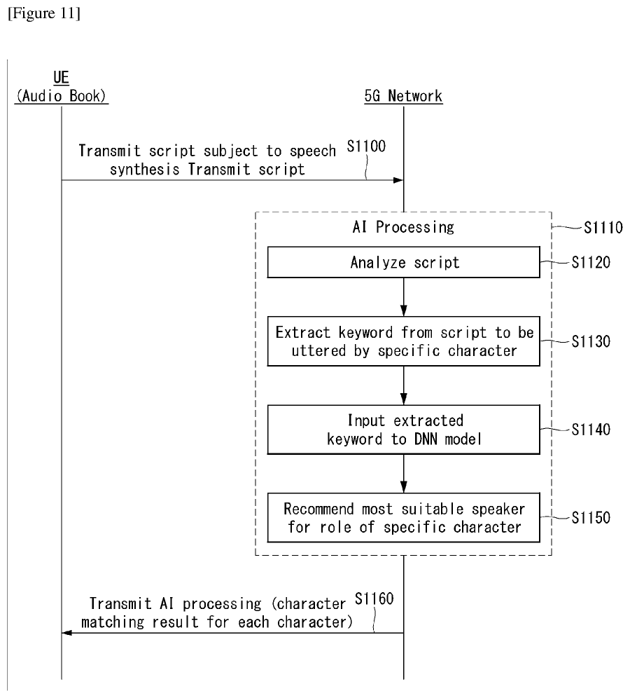

FIG. 11 is another exemplary flowchart of a method for setting a speaker according to an embodiment of the present invention.

Referring to FIG. 11, the TTS device (hereinafter, referred to as an audiobook) may transmit a script, subject to speech synthesis, to a 5G network (S1100).

The 5G network may include a server having an AI system. The server may generate a speaker matching result for each character through AI processing (S1110).

The AI processing (S1110) is implemented as the AI system, and the AI system analyzes a script received from the audiobook through a wireless communication unit (S1120). The AI system may differentiate multiple characters from the script. The AI system may extract a keyword from a script uttered by a specific character among the differentiated multiple characters (S1130). The AI system may configure the extracted keyword as an input value to a DNN model (S1140). The DNN model is a model that has been trained to determine a speaker having a voice most suitable for each character on the basis of the extracted keyword. The AI system may recommend the most suitable speaker for a role of a specific character based on an output value of the DNN model (S1150).

The AI system may transmit a speaker matching result for each character, which corresponds to an AI processing result, to the audiobook through the wireless communication unit (S1160).

Hereinafter, example of speaker information in a script of the TTS device through SSML will be described.

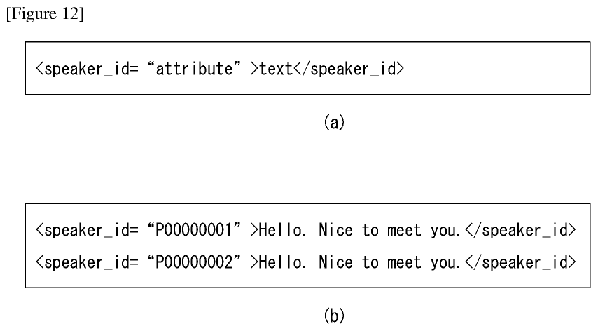

FIG. 12 is an example of expressing speaker ID in SSML and applying the speaker ID to utterance.

Referring to (a) of FIG. 12, speaker ID may be expressed as <speaker_id=“attribute”> text </speaker_id> in SSML. Here, the “attribute” is a unique ID for identifying a speaker, and the speaker ID may be described in a speaker profile element. The “text” may correspond to a source to be uttered through speech synthesis, and the “speaker_id” may be an indicator for identifying the speaker.

Referring to (b) of FIG. 12, a text “Hello, nice to meet you” may be

synthesized with a voice of a first speaker having a unique ID of “P00000001” and with a voice of a second speaker having a unique ID of “P00000002” and then output. In a case where a speaker Id is different, it may be considered that a voice characteristic is different. Different speaker IDs may be given for even the same speaker, and, in this case, speech synthesis may be performed using voices of the same speaker with different speech characteristics

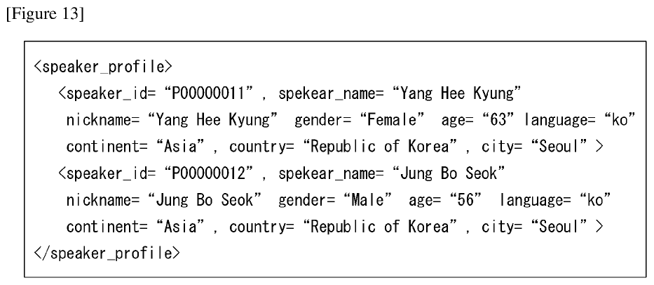

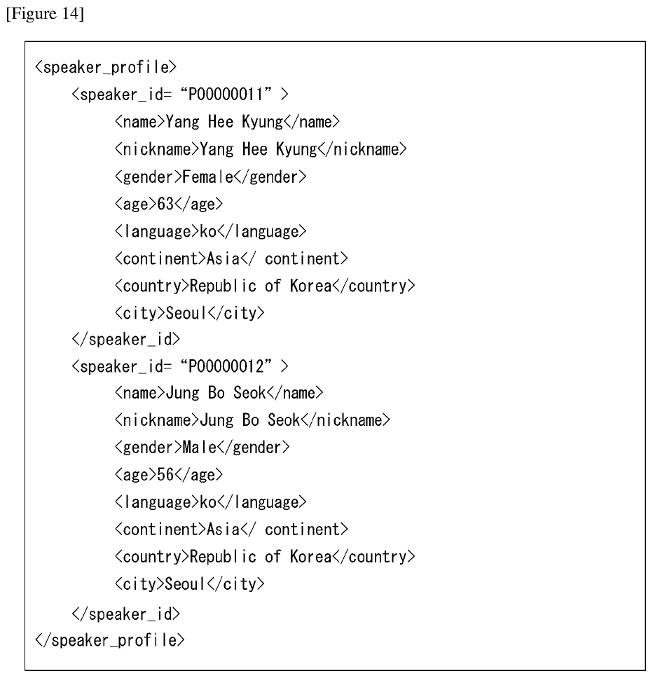

FIGS. 13 and 14 are examples of expressing a speaker profile in SSML.

FIG. 13 is an example of describing a speaker profile in SSML.

A speaker profile element may be composed of <speaker_profile> and </speaker_profile>. The speaker profile element is a method of expressing multiple characteristics of a speaker in elements, and may express a name of a character acted by the speaker, gender of the speaker, age of the speaker, language used by the speaker, a continent to which the speaker belongs, a country to which the speaker belongs, a city to which the speaker belongs to, etc. In addition, the speaker profile element of the present invention is not limited to the aforementioned examples and may extend to various elements in addition to the aforementioned examples.

FIG. 13 is an example of an abbreviated expression of a speaker profile, and FIG. 14 shows an enumerated expression of a speaker profile.

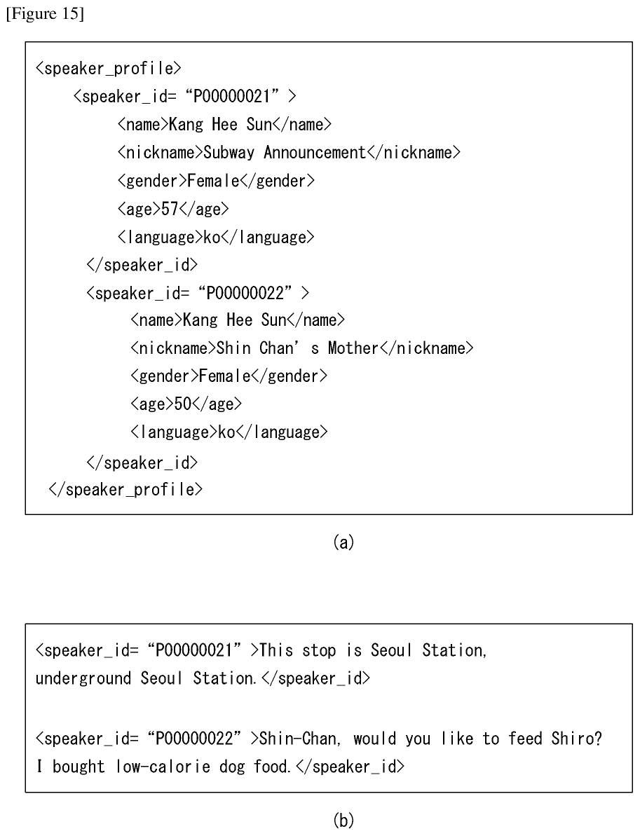

FIG. 15 is an example of setting the same speaker for multiple characters using SSML, whilst setting different speaker IDs and applying the different speaker IDs to utterance.

Referring to (a) of FIG. 15, the TTS method for enabling setting of multiple characters according to an embodiment of the present invention may enable different speaker IDs to be registered for different voices in a case where the same person such as a voice actor acts using the difference voices. For example, the voice actor “Kang Hee Sun” may be registered with speaker ID of “P00000021” (a first speaker ID) and speaker ID of “P00000022” (a second speaker ID).

The processor 170 may select the first speaker ID for speech synthesis of “Subway Announcement” and the second speaker ID for speech synthesis of “Shin-Chan's Mother”

FIG. 15 (b) shows an example of SSML representation to perform speech synthesis on scripts of different characters which is to be spoken by the same speaker using the first speaker (the first speaker ID) and the second speaker (the second speaker ID).

Meanwhile, according to an embodiment, speech synthesis may be performed by adding a speaker related element and a story related element to SSML.

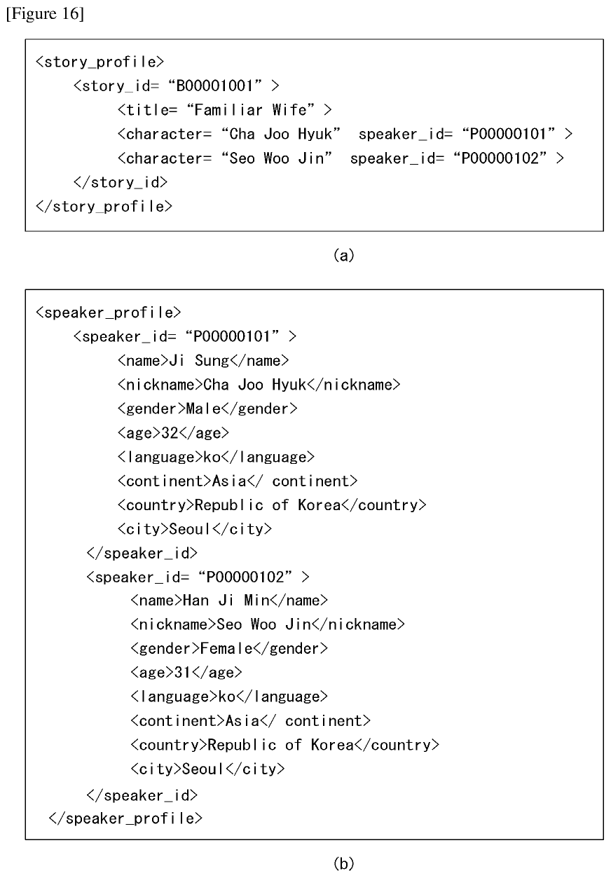

FIG. 16 is an example of expressing a story ID and a story profile in SSML.

FIG. 16(a) is an example of using a story ID and a story profile.

The Story_id, which is ID for identifying an audiobook, may be generated at the beginning of reading the audiobook.

The “title” is a title of the audiobook and may include a drama title, a movie title, a fairytale story title, a song title, etc. The “character” is a character presented in the audio book and may be defined as having a unique characteristic of the character included in the audiobook. Such a characteristic may be defined as a character's personality: for example, the character “Cha Joo Hyuk” in “Familiar Wife” can be defined as an average ordinary Korean man in his thirties who graduated a university and works at a bank. In addition, the character “Seo Woo Jin” may be defined as having a characteristic of a woman in her thirties who became a mother too early and who is struggling to work for a living while taking care of her child at the same time. Such a characteristic may be reflected in a script. FIG. 16(a) shows that “Cha Joo Hyuk” in “Familiar Wife” is set as a first speaker ID and “Seo Woo Jin” is set as a second speaker ID. FIG. 16(b) shows an example of a format in which a story profile and a speaker profile are combined and transmitted to the speech synthesis engine in the form of a metadata.

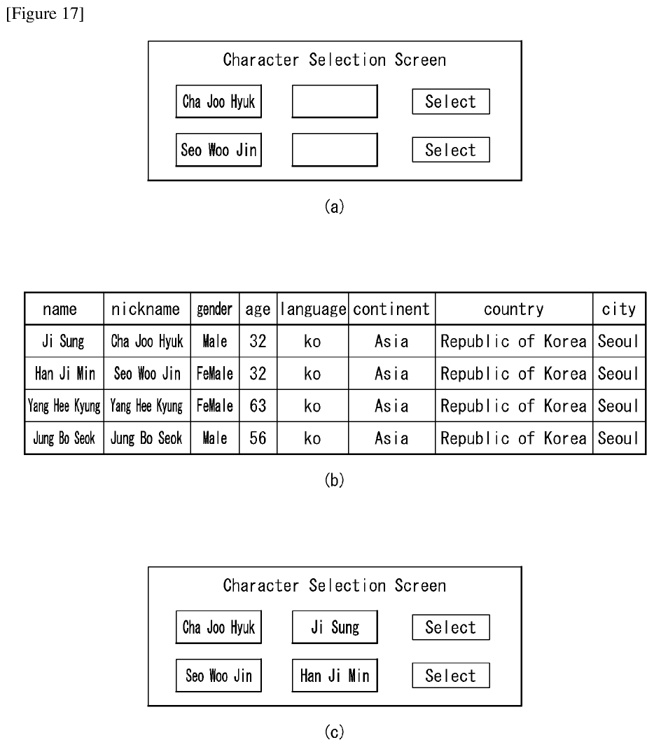

FIG. 17 is an example of matching a character included in a script of an audio book and a speaker according to an embodiment of the present invention.

Referring to FIG. 17(a), the TTS device enabling multiple speakers to be set according to an embodiment of the present invention may provide, to a display unit, a user interface for selecting a speaker whose voice is to be used for synthesize of a speech of a character included in a specific story. The user interface may search for a desired person from speaker profiles through an input of Select button on a character selection screen (see FIG. 17(b)).

A speaker whose voice is to be used for synthesis of a speech of a specific character included in an audiobook may be selected through an input of Select button of a character selection screen (see FIG. 17(c)).

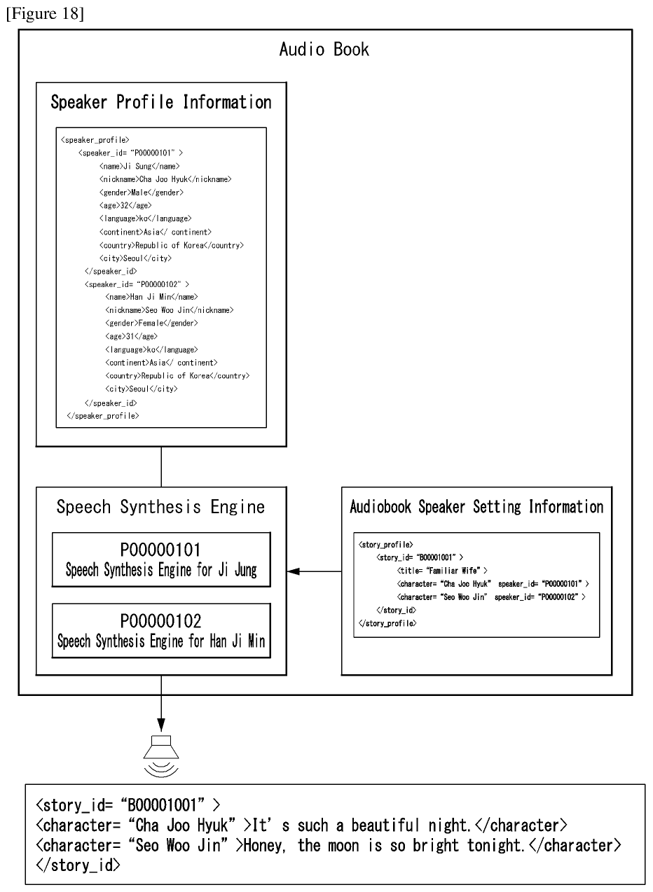

FIG. 18 is an example in which an audiobook is output in SSML after a speaker is set according to an embodiment of the present invention.

Referring to FIG. 18, an audiobook may be expressed in SSML after speaker profile information is searched and a specific speaker is selected. The audiobook may configure speaker setting information by matching a character and a speaker ID and representing a speaker matching result in SSML. The audio book may transmit the speaker setting information to the speech synthesis engine. The speech synthesis engine may perform speech synthesis by using SSML, in which different speaker IDs for multiple characters are set, as metadata.

The audiobook may output, through the acoustic output unit, a speech synthesis result in which multiple characters in one story is synthesized with voices of different speakers.

A system according to another aspect of the present invention includes: a means configured to set speaker information for multiple characters with respect to a script that is composed to enable utterance by the multiple characters; a means configured to transmit metadata, comprising the speaker information corresponding to the multiple characters, together with the script to a speech synthesis unit; and a means configured to perform speech synthesis by the speech synthesis unit based on the metadata; and a means configured to output a result of the speech synthesis through an acoustic output unit.

The system may be composed of an audiobook and a server, and the means configured to set speaker information may be the server. The audiobook may receive the set speaker information as metadata from the server through a wireless communication unit, and perform speech synthesis based on the metadata.

An electronic device according to yet another aspect of the present invention includes: one or more processors; a memory; and one or more programs, wherein the one or more programs are stored in the memory and configured to be executed by the one or more processors and comprises an instruction for implementing the above-described method enabling multiple speakers to be set.

The electronic device may be implemented as an AI speaker in an audiobook form, a robot for speech guidance, etc.

A recording medium according to yet another aspect of the present invention is a non-transitory computer-executable component in which a computer-executable component configured to be executed by one or more processors of a computing device is stored, wherein the computer-executable component is configured to: set speaker information for multiple characters with respect to a script that is composed to enable utterance by the multiple characters; transmit metadata, comprising the speaker information corresponding to the multiple characters, together with the script to a speech synthesis unit; and, based on the metadata, perform speech synthesis by the speech synthesis unit.

The recording medium may be implemented as a module and embedded and may perform speech synthesis which enables multiple speakers to be set by a processor for controlling a recording medium module.

The above-described present invention can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Furthermore, although the invention has been described with reference to the exemplary embodiments, those skilled in the art will appreciate that various modifications and variations can be made in the present invention without departing from the spirit or scope of the invention described in the appended claims. For example, each component described in detail in embodiments can be modified. In addition, differences related to such modifications and applications should be interpreted as being included in the scope of the present invention defined by the appended claims.

Although description has been made focusing on examples in which the present invention is applied to automated vehicle & highway systems based on 5G (5 generation) system, the present invention is also applicable to various wireless communication systems and autonomous devices.

The above-described present invention can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Furthermore, although the invention has been described with reference to the exemplary embodiments, those skilled in the art will appreciate that various modifications and variations can be made in the present invention without departing from the spirit or scope of the invention described in the appended claims. For example, each component described in detail in embodiments can be modified. In addition, differences related to such modifications and applications should be interpreted as being included in the scope of the present invention defined by the appended claims.

Although description has been made focusing on examples in which the present invention is applied to automated vehicle & highway systems based on 5G (5 generation) system, the present invention is also applicable to various wireless communication systems and autonomous devices.

1. A text-to-speech (TTS) method enabling multiple speakers to be set, the method comprising:
setting speaker information for the multiple characters with respect to a script configured such that utterance can be spoken by the multiple character;
transmitting metadata, comprising the speaker information corresponding to the multiple characters, together with the script to a speech synthesis unit;
performing, by the speech synthesis unit, speech synthesis based on the metadata; and
outputting a result of the speech synthesis to an acoustic output unit.

2. The method of claim 1, wherein the metadata is described in markup language, and the markup language comprises speech synthesis markup language (SSML).

3. The method of claim 2,
wherein the SSML comprises an element for expressing the speaker information, and
wherein the element comprises at least one of speaker_id, speaker_profile, story_id, or story profile.

4. The method of claim 3, wherein the speaker_id is used to identify a speaker and described together with at least a part of the script that is subject to the speech synthesis.

5. The method of claim 3, wherein the speaker_profile comprises at least one of the following: the speaker id, name of the speaker, a character to be synthesized with a voice of the speaker, age of the speaker, language used by the speaker, a country of the speaker, a continent to which the country of the speaker belongs to, and a city to which the speaker belongs.

6. The method of claim 5, wherein when voices of different characters are synthesized by a same speaker, different speaker IDs are respectively set for the different characters.

7. The method of claim 6, wherein the speaker_profile is described using an independent speaker ID set for the speaker_id.

8. The method of claim 3, wherein the story_id is an identifier for identifying a content on which speech synthesis is to be performed based on the script.

9. The method of claim 3,
wherein the story_profile comprise at least one of the story_id, a story title, a character included in the story, or the speaker_id, and
wherein the character is described as being matched with the speaker_id.

10. The method of claim 1, further comprising storing the speaker information in a storage,
wherein the setting the speaker information for the multiple characters further comprises:
searching for the stored speaker information based on an input received through a user input unit; and
matching the speaker information for each of the multiple characters based on the input received through the user input unit.

11. The method of claim 1, wherein the setting of the speaker information for the multiple characters further comprises:
extracting keywords of the multiple characters by analyzing characteristics of the multiple characters included in the script;
based on the keywords, searching for speaker information stored in a memory; and
matching speaker information, determined suitable for the keywords, with the multiple characters.

12. The method of claim 1, wherein the setting of the speaker information for the multiple characters is performed by receiving speaker information matched with each of the multiple characters from an external server.

13. A text-to-speech (TTS) device enabling multiple speakers to be set, the device comprising:
a speech synthesis unit;
a memory configured to store information on the multiple speakers and a script; and
a processor configured to control the speech synthesis unit to synthesize a speech corresponding to the script by reflecting speaker information set in the script,
wherein the processor is configured to:
set the information on the speakers for the multiple characters with respect to the script that is composed to enable utterance by the multiple characters;
transmit metadata, including the information on the speakers corresponding to the multiple characters, together with the script to the speech synthesis unit;
based on the metadata, perform speech synthesis by the speech synthesis unit; and
output a result of the speech synthesis through an acoustic output unit.

14. The device of claim 13, wherein the TTS device is an audio book.

15. The device of claim 13, wherein the TTS device is an Artificial Intelligence (AI) speaker including an AI module capable of performing AI processing.

16. A system comprising:
a means configured to set speaker information for multiple characters with respect to a script that is composed to enable utterance by the multiple characters;
a means configured to transmit metadata, comprising the speaker information corresponding to the multiple characters, together with the script to a speech synthesis unit; and
a means configured to perform speech synthesis by the speech synthesis unit based on the metadata; and
a means configured to output a result of the speech synthesis through an acoustic output unit.

17. An electronic device comprising:
one or more processors;
a memory; and
one or more programs, wherein the one or more programs are stored in the memory and configured to be executed by the one or more processors and comprises an instruction for implementing the method of claim 1.

18. A non-transitory computer-executable component in which a computer-executable component configured to be executed by one or more processors of a computing device is stored, wherein the computer-executable component is configured to:
set speaker information for multiple characters with respect to a script that is composed to enable utterance by the multiple characters;
transmit metadata, comprising the speaker information corresponding to the multiple characters, together with the script to a speech synthesis unit; and
based on the metadata, perform speech synthesis by the speech synthesis unit.
